(19) United States
(12) Patent Application Publication
(10) Pub. No.: US 2026/0061812 A1
(43) Pub. Date: Mar. 5, 2026

(54) CORNER STRUCTURE OF GLASS RUN AND METHOD OF MANUFACTURING CORNER STRUCTURE

(71) Applicant: NISHIKAWA RUBBER CO., LTD., Hiroshima (JP)

(72) Inventor: Yukio MURAKAMI, Hiroshima (JP)

(21) Appl. No.: 19/300,288

(22) Filed: Aug. 14, 2025

(30) Foreign Application Priority Data
Aug. 29, 2024 (JP) 2024-147779

(51) Int. Cl. B60J 10/76; B29C 48/00; B29C 48/12; B29L 31/30; B60J 10/21; B60J 10/24

(52) U.S. Cl. CPC B60J 10/76; B29C 48/0011; B29C 48/12; B60J 10/21; B60J 10/24; B29L 2031/3005

(57) ABSTRACT

To provide a corner structure capable of making a glass-run body and a sealing part difficult to come apart. A corner structure (1) of a glass run configured to be attached to an automobile, includes: a glass-run body (2) configured to be attached to a periphery of a door of the automobile; and a hollow sealing part (3) configured to fill a parting portion which is present between a front door and a rear door of the automobile, or a parting portion which is present between the rear door and a vehicle body of the automobile. The glass-run body (2) and the sealing part (3) are integrally molded.

This Nonprovisional application claims priority under 35 U.S.C. § 119 on Patent Application No. 2024-147779 filed in Japan on Aug. 29, 2024, the entire contents of which are hereby incorporated by reference.

### TECHNICAL FIELD

The present disclosure relates to a corner structure of a glass run configured to be attached along a frame body provided in a door of an automobile, to guide a door glass that moves up and down to the groove, and also relates to a method of manufacturing the corner structure.

### Background Art

FIG. 7 is a side view of an automobile illustrating its left-side appearance. As illustrated in FIG. 7, a glass run 20 is attached along a roof-side frame body RF and a pillar-side frame body P of each of a front door F and a rear door R of the automobile, to guide a door glass 10 that moves up and down.

Patent Literature 1 discloses a groove structure of a rear portion of a rear door of an automobile. As illustrated in FIGS. 6 and 7 of Patent Literature 1, the groove structure of Patent Literature 1 joins a groove body 1 and a corner part 2 using a mounting block 201 in order to facilitate assembly of the groove body 1 and the corner part 2.

### CITATION LIST

### Patent Literature

[Patent Literature 1]

Chinese Utility Model Registration No. 216101488

### SUMMARY OF INVENTION

### Technical Problem

However, since the groove structure of Patent Literature 1 has a structure in which the groove body 1 (corresponding to a sealing part) and the corner portion 2 (corresponding to a glass-run body) are joined together with the mounting block 201, the groove body 1 and the corner part 2 can easily come apart.

The present disclosure has been made in view of this problem, and an object thereof is to provide a corner structure of a glass run and a method of manufacturing the corner structure, the corner structure being capable of making a glass-run body and a sealing part difficult to come apart.

### Solution to Problem

To achieve the object, a corner structure of a glass run in accordance with an aspect of the present disclosure, includes: a glass-run body configured to be attached to a periphery of a door of an automobile; and a hollow sealing part configured to fill a parting portion which is present between a front door and a rear door of the automobile, or a parting portion which is present between the rear door and a vehicle body of the automobile, wherein the glass-run body and the sealing part are integrally molded.

To achieve the object, a method of manufacturing a corner structure of a glass run in accordance with an aspect of the present disclosure, includes: forming, by extrusion molding, a hollow sealing part configured to fill a parting portion which is present between a front door and a rear door of an automobile, or a parting portion which is present between the rear door and a vehicle body of the automobile; and placing the sealing part formed by the extrusion molding in a molding die for shaping the corner structure of a glass-run body, to integrally mold the glass-run body and the sealing part.

### Advantageous Effects of Invention

According to an aspect of the present disclosure, it is possible to provide a corner structure capable of making the glass-run body and the sealing part difficult to come apart.

### BRIEF DESCRIPTION OF DRAWINGS

FIG. 1 is a perspective view of a vehicle-exterior side of a corner structure in accordance with the present disclosure.

FIG. 2 is a perspective view of a vehicle-interior side of the corner structure in accordance with the present disclosure.

FIG. 3 is a schematic diagram illustrating how a core is mounted in a glass-run body and a sealing part.

FIG. 4 is a schematic diagram illustrating how the core is removed from the glass-run body and the sealing part.

FIG. 5 is a flowchart of a method of manufacturing the corner structure in accordance with the present disclosure.

FIG. 6 is a diagram illustrating an example of the mold structure for integrally molding the glass-run body and the sealing part.

FIG. 7 is a side view of an automobile illustrating its left-side appearance.

### DESCRIPTION OF EMBODIMENTS

The following will describe a corner structure 1 in accordance with the present disclosure and a method of manufacturing the corner structure 1, with reference to the drawings.

### Corner Structure 1

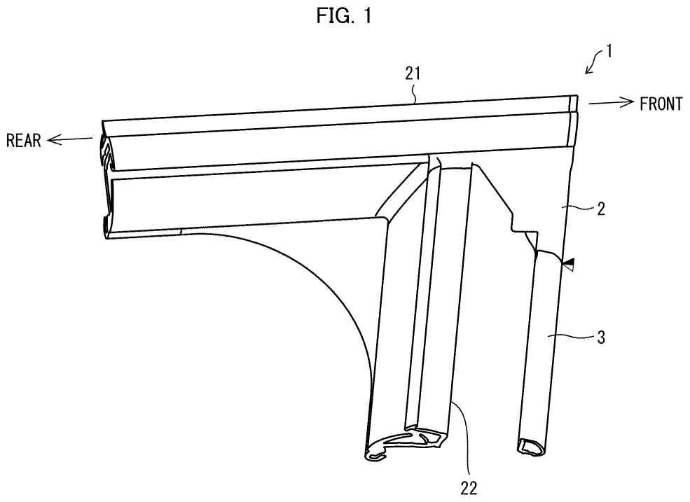

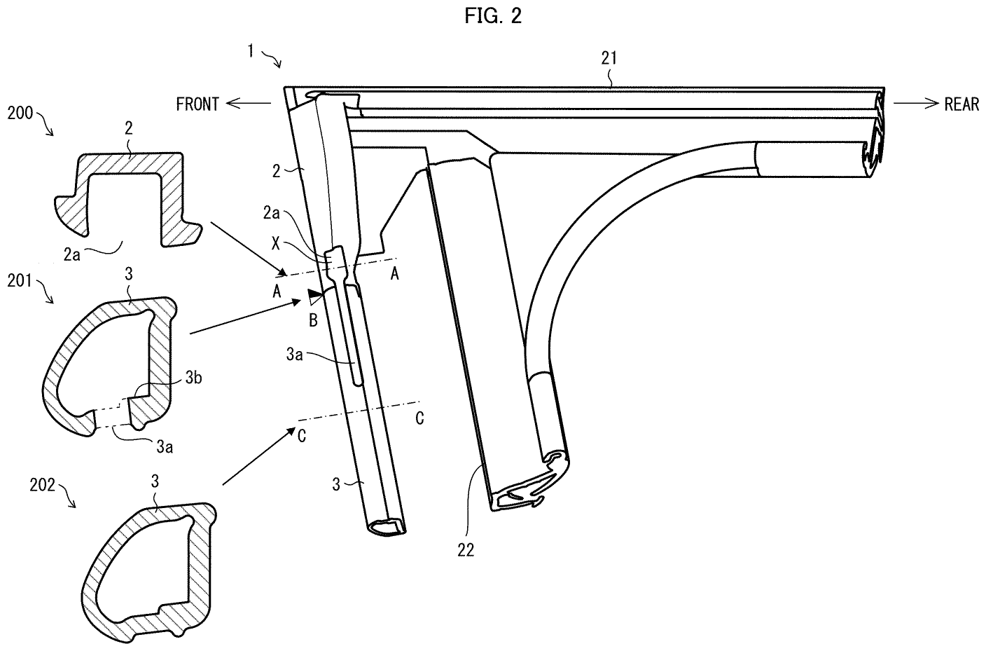

FIG. 1 is a perspective view of a vehicle-exterior side of the corner structure 1 in accordance with the present disclosure. FIG. 2 is a perspective view of a vehicle-interior side of the corner structure 1 in accordance with the present disclosure. FIGS. 1 and 2 depict a glass run 20 configured to be attached along an upper front corner of a rear door R.

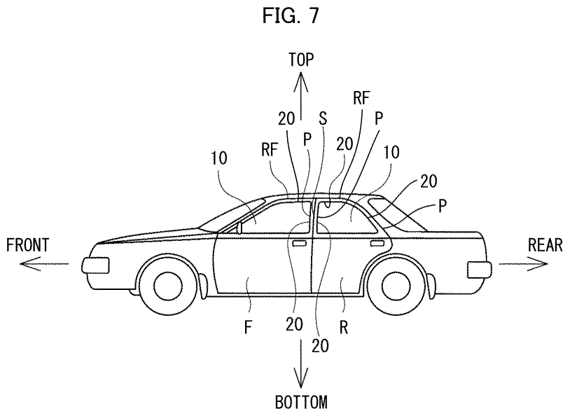

First, an outline of the corner structure 1 will be described. As described above in the conventional example with reference to FIG. 7, the corner structure 1 of the glass run is attached along a roof-side frame body RF and a pillar-side frame body P of each of a front door F and a rear door R of an automobile. The corner structure 1 includes: a glass-run body 2 configured to be attached to a periphery of a door of the automobile; and a hollow sealing part 3 configured to fill a parting portion which is present between a front door and a rear door of the automobile, or a parting portion which is present between the rear door and a vehicle body of the automobile. The glass-run body 2 and the sealing part 3 are integrally molded. In FIGS. 1 and 2, a black-and-white bicolor triangle indicates that the black side is the glass-run body 2 and the white side is the sealing part 3. Next, the glass-run body 2 and the sealing part 3 will be described with reference to FIGS. 1 and 2.

### Glass-Run Body 2

The glass-run body 2 is configured to be attached to a periphery of a door of the automobile, and includes an elongated body 21 and elongated body 22 attached along the roof-side frame body RF and the pillar-side frame body P, respectively. The elongated body 21 and the elongated body 22 are generally formed by extrusion molding, which are integrated by molding using a molding die and constitute the glass-run body 2. The glass-run body 2 has a core removal hole 2a configured to be positioned on a vehicle-interior side of the automobile and configured to allow removal of a core 8 (described later) inserted in the sealing part 3. Since the core removal hole 2a is formed at a position to be located on the vehicle-interior side of the automobile, it is possible to prevent rainwater from flowing in through the core removal hole 2a and it is also possible to keep the appearance (attractive appearance) of the automobile.

A diagram with the reference number 200 in FIG. 2 is an enlarged cross-sectional view taken along line A-A illustrated in FIG. 2. In area X in which the core removal hole 2a is formed, the glass-run body 2 is formed to have a substantially U-shaped cross section. The glass-run body 2 has the core removal hole 2a near the boundary between the glass-run body 2 and the sealing part 3. This enables the core 8 (described later) used during forming of the sealing part 3 to be easily removed from the core removal hole 2a and the slit 3a.

The area X in which the core removal hole 2a is formed only needs to be formed by molding using a molding die, using an elastic material. For example, the area X in which the core removal hole 2a is formed may be made of an elastic material that may be thermoplastic elastomers such as a thermoplastic olefinic elastomer (TPO) and a thermoplastic styrenic elastomer (TPS), or various rubbers such as ethylene-propylene-diene copolymer rubber (EPDM). Since the area X in which the core removal hole 2a is formed is required to have a certain degree of rigidity, it is preferable that the core removal hole 2a be made of a non-foamed material, but may be made of a low-foamed material. It should be noted that the abovementioned molding using a molding die to integrate the elongated body 21 and the elongated body 22 may be performed using an elastic material that is the same as that of the region X in which the core removal hole 2a is formed, or may be performed using another different elastic material. Further, the molded portion formed by molding using a molding die to integrate the elongated body 21 and the elongated body 22 may continuously form the area X in which the core removal hole 2a is formed, or alternatively, may be a separated different molded body.

### Sealing Part 3

The sealing part 3 is for use in filling a parting portion which is present between a front door and a rear door of the automobile, or a parting portion which is present between a rear door and a vehicle body of the automobile. Since the sealing part 3 is formed in a hollow shape, this provides high contact tightness, superior sealing performance, and good appearance. The sealing part 3 has, at a position to be located on the vehicle-interior side of the automobile, the slit 3a extending in the longitudinal direction of the sealing part 3, and the slit 3a and the core removal hole 2a are connected. The longitudinal direction of the sealing part 3 is a direction in which the sealing part 3 extends, and it should be understood that the longitudinal direction is a direction in which the pillar-side frame body P of the automobile extends (substantially vertical direction in the drawing).

A diagram with the reference number 201 in FIG. 2 is an enlarged cross-sectional view of section B serving as the boundary between the glass-run body 2 and the sealing part 3. The sealing part 3 is formed to have a substantially C-shaped cross-section in the area where the slit 3a is formed. Thus, the sealing part 3 has an opening with its periphery partially cut away. This opening continuously extends in the longitudinal direction of the sealing part 3, to form the slit 3a, which is connected to the core removal hole 2a.

The sealing part 3 may have a face 3b in a cross-sectional view and the slit 3a may be formed in a central portion of the face 3b, but this is not limited thereto. This configuration makes it easy to form the slit 3a in the sealing part 3, so that it is possible to increase the yield of the sealing part 3 having the slit 3a. Further, with this configuration, it is possible to reduce the risk of damage to the sealing part 3 that might occur in removal of the core 8 from the slit 3a.

A diagram with the reference number 202 in FIG. 2 is an enlarged cross-sectional view taken along line C-C illustrated in FIG. 2. In this position, the sealing part 3 does not have the slit 3a and thus does not have the abovementioned opening.

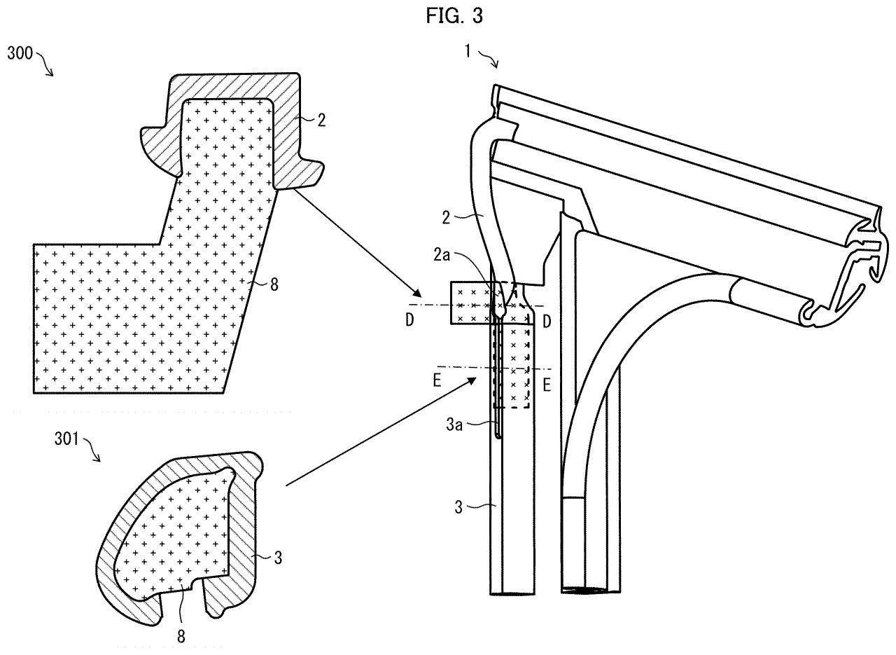

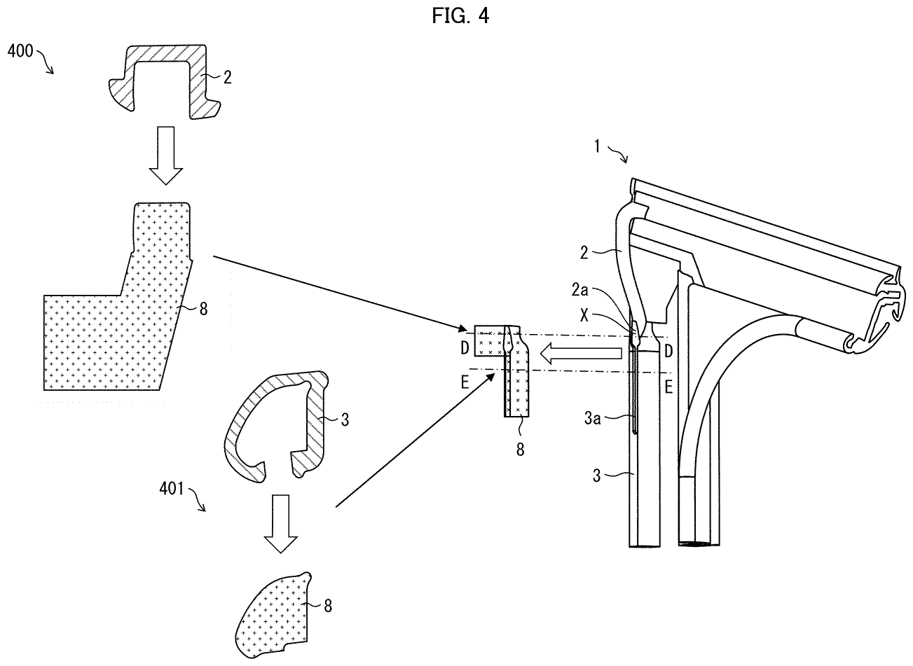

Each of the core removal hole 2a and the slit 3a may have a longitudinal length and a width in the front-to rear direction of the automobile that are appropriately determined depending on the longitudinal length of the core 8, which will be described later with reference to FIGS. 3 and 4.

In the foregoing, the cross-sectional shapes of the glass-run body 2 and the sealing part 3 are described with reference to the diagrams with the reference numbers 200 to 202 in FIG. 2. These shapes are merely examples and may be appropriately determined depending on the design or the like of the automobile.

The sealing part 3 only needs to be formed by extrusion molding using an elastic material. For example, the sealing part 3 may be made of an elastic material that may be thermoplastic elastomers such as a thermoplastic olefinic elastomer (TPO) and a thermoplastic styrenic elastomer (TPS), or various rubbers such as ethylene-propylene-diene copolymer rubber (EPDM). The sealing part 3 may be made of a foamed material, or alternatively, may be made of a low-foamed material or a non-foamed material.

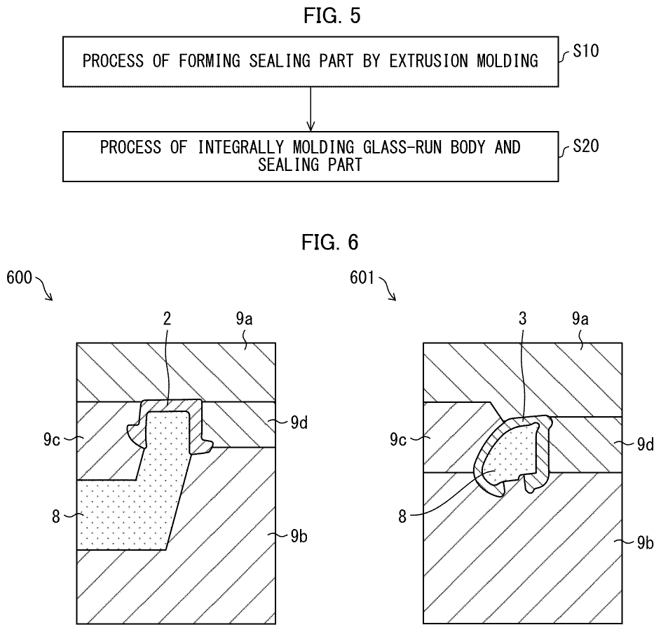

The glass-run body 2 and the sealing part 3 are integrally molded to make the glass-run body 2 and the sealing part 3 difficult to come apart. This will be described later with reference to FIG. 5.

### Core 8

Next, FIG. 3 is a schematic diagram illustrating how the core 8 is mounted in the glass-run body 2 and the sealing part 3.

The core 8 is for use in integrally molding the glass-run body 2 and the sealing part 3. A diagram with the reference number 300 in FIG. 3 is an enlarged cross-sectional view taken along line D-D illustrated in FIG. 3. The core 8 partially projects from the core removal hole 2a to the outside of the glass-run body 2. A diagram with the reference number 301 in FIG. 3 is an enlarged cross-sectional view taken along line E-E illustrated in FIG. 3. The outer shape of the core 8 conforms to the inner shape of the sealing part 3. Here, it is assumed that the lower side of the drawing is defined as the “bottom”, the bottom surface of the core 8 may be positioned higher than the lower end of the sealing part 3 because the core 8 is configured to be pulled out from the slit 3a, but this is not limited thereto.

Next, FIG. 4 is a schematic diagram illustrating how the core 8 is removed from the glass-run body 2 and the sealing part 3. A diagram with the reference number 400 in FIG. 4 is an enlarged cross-sectional view taken along line D-D illustrated in FIG. 4. A diagram with the reference number 401 in FIG. 4 is an enlarged cross-sectional view taken along line E-E illustrated in FIG. 4. As illustrated, the core 8 is removed to the outside of the glass-run body 2 and the sealing part 3. At this time, the core 8 is removed to the outside of the glass-run body 2 and the sealing part 3 through the core removal hole 2a and the slit 3a, so that it is possible to reduce the risk of damage to the glass-run body 2 and the sealing part 3 that might occur in removal of the core 8. Thus, it is possible to facilitate realizing the automation of the removal operation of the core 8 that can be done without damaging the glass-run body 2 and the sealing part 3.

### Method of Manufacturing Corner Structure 1

Next, a method of manufacturing the corner structure 1 will be described with reference to FIG. 5. FIG. 5 is a flowchart of the method of manufacturing the corner structure 1.

First, a hollow sealing part 3 configured to fill a parting portion which is present between a front door and a rear door of the automobile, or a parting portion which is present between the rear door and a vehicle body of the automobile is formed by extrusion molding (S10). Next, the sealing part 3 formed by the extrusion molding is placed in a molding die for shaping the area X in which a core removal hole 2a of a glass-run body 2 is formed, to integrally mold the glass-run body 2 and the sealing part 3 (S20). At this time, if the elongated bodies 21 and 22 formed by extrusion molding are also integrated at the same time, the elongated bodies 21 and 22 may also be placed in the molding die.

FIG. 6 is a diagram illustrating an example of the mold structure for integrally molding the sealing part 3 and the area X in which the core removal hole 2a of the glass-run body 2 is formed. In the example illustrated in FIG. 6, molding dies 9a, 9b, 9c, and 9d are used to integrally mold the sealing part 3 and the area X in which the core removal hole 2a of the glass-run body 2 is formed. A diagram with the reference number 600 in FIG. 6 is a cross-sectional view taken along line D-D illustrated in FIG. 4, with the molding dies depicted. A diagram with the reference number 601 in FIG. 6 is a cross-sectional view taken along line E-E illustrated in FIG. 4, with the molding dies depicted.

Mold disassembly during demolding may be carried out automatically. As an example, first, the molding die 9a is removed upward. Next, the molding die 9b is removed downward. Then, the core 8 is removed from both the glass-run body 2 and the sealing part 3, and then, the molding dies 9c and 9d are removed. Here, as an alternative disassembly order, the molding dies 9c and 9d may be removed before the core 8 is removed from both the glass-run body 2 and the sealing part 3.

According to the foregoing, the glass-run body 2 and the sealing part 3 are integrally molded, so that it is possible to manufacture the corner structure 1 that can make the glass-run body 2 and the sealing part 3 difficult to come apart. Further, since the glass-run body 2 and the sealing part 3 are joined together by molding using a molding die, it is possible to manufacture the corner structure 1 in a single molding process, resulting in an increase in productivity. In addition, since the number of parts can be reduced, it is also possible to facilitate storage, transportation, and the like.

Integral molding of the glass-run body 2 and the sealing part 3 may be targeted for a section between the front roof and the B pillar, a section between the rear roof and the B pillar, and a section between the rear roof and the C pillar, so that it is possible to achieve various advantageous effects described herein at these sections.

### SUMMARY

A corner structure of a glass run in accordance with Aspect 1 of the present disclosure is a corner structure of a glass run configured to be attached to an automobile, the structure including: a glass-run body configured to be attached to a periphery of a door of the automobile; and a hollow sealing part configured to fill a parting portion which is present between a front door and a rear door of the automobile, or a parting portion which is present between the rear door and a vehicle body of the automobile, wherein the glass-run body and the sealing part are integrally molded.

With this configuration, the corner structure of the glass run in accordance with Aspect 1 of the present disclosure can make the glass-run body and the sealing part difficult to come apart.

Further, according to this configuration, the corner structure of the glass run in accordance with Aspect 1 of the present disclosure has the sealing part (parting-sealing part) that is hollow. Thus, it is also possible to provide high contact tightness, superior sealing performance, and good appearance.

The corner structure of the glass run in accordance with Aspect 2 of the present disclosure has a configuration, in Aspect 1 above, in which the glass-run body has a core removal hole configured to be positioned on a vehicle-interior side of the automobile, the core removal hole being configured to allow removal of a core inserted in the sealing part.

If the core removal hole were positioned on the vehicle-exterior side of the automobile, there might be problems in that, for example, rainwater may be allowed to flow in through the core removal hole, and the attractive appearance of the automobile may be degraded. In this regard, since the corner structure of the glass run in accordance with Aspect 2 of the present disclosure has the core removal hole that is positioned on the vehicle-interior side of the automobile, it is possible to prevent rainwater from flowing in through the core removal hole and it is also possible to keep the attractive appearance of the automobile.

The corner structure of the glass run in accordance with Aspect 3 of the present disclosure has a configuration, in Aspect 2 above, in which the sealing part has a slit configured to be positioned on a vehicle-interior side of the automobile, the slit extending in a longitudinal direction of the sealing part, and the slit and the core removal hole are connected.

With this configuration, it is possible to provide the corner structure of the glass run in accordance with Aspect 3 of the present disclosure, capable of allowing the core to be pulled out through the core removal hole and the slit. Thus, it is possible to provide the corner structure of the glass run in accordance with Aspect 3 of the present disclosure, capable of reducing the risk of damage that might occur when the core is pulled out; this also enables the core pulling operation to be automated. Further, the sealing part having this configuration may also have the advantage of being easy to mass-produce.

A method of manufacturing a corner structure of a glass run in accordance with Aspect 4 of the present disclosure is a method of manufacturing a corner structure of a glass run configured to be attached to an automobile, the method including: forming, by extrusion molding, a hollow sealing part configured to fill a parting portion which is present between a front door and a rear door of the automobile, or a parting portion which is present between the rear door and a vehicle body of the automobile; and placing the sealing part formed by the extrusion molding in a molding die for shaping the corner structure of a glass-run body, to integrally mold the glass-run body and the sealing part.

With this configuration, the method of manufacturing the corner structure of the glass run in accordance with Aspect 4 of the present disclosure can manufacture the corner structure of the glass run in accordance with Aspect 1 of the present disclosure.

### Additional Remarks

The present disclosure is not limited to the embodiments mentioned above, but can be variously altered within the scope of the claims. The present disclosure also encompasses, in its technical scope, any embodiment derived by appropriately combining technical means disclosed in differing embodiments.

### REFERENCE SIGNS LIST

1 Corner structure
2 Glass-run body
2a Core removal hole
3 Sealing part
3a Slit
8 Core
9a, 9b, 9c, 9d Molding die
20 Glass run
F Front door
R Rear door
RF Roof-side frame body
P Pillar-side frame body

1. A corner structure of a glass run configured to be attached to an automobile, the structure comprising:
a glass-run body configured to be attached to a periphery of a door of the automobile; and
a hollow sealing part configured to fill a parting portion which is present between a front door and a rear door of the automobile, or a parting portion which is present between the rear door and a vehicle body of the automobile,
wherein the glass-run body and the sealing part are integrally molded.

2. The corner structure of the glass run according to claim 1, wherein the glass-run body has a core removal hole configured to be positioned on a vehicle-interior side of the automobile, the core removal hole being configured to allow removal of a core inserted in the sealing part.

3. The corner structure of the glass run according to claim 2, wherein
the sealing part has a slit configured to be positioned on a vehicle-interior side of the automobile, the slit extending in a longitudinal direction of the sealing part, and
the slit and the core removal hole are connected.

4. A method of manufacturing a corner structure of a glass run configured to be attached to an automobile, the method comprising:
forming, by extrusion molding, a hollow sealing part configured to fill a parting portion which is present between a front door and a rear door of the automobile, or a parting portion which is present between the rear door and a vehicle body of the automobile; and
placing the sealing part formed by the extrusion molding in a molding die for shaping the corner structure of a glass-run body, to integrally mold the glass-run body and the sealing part.
